(19) United States
(12) Patent Application Publication
(10) Pub. No.: US 2011/0290472 A1
(43) Pub. Date: Dec. 1, 2011

(54) PROCESS FOR MANUFACTURING SWELLABLE DOWNHOLE PACKERS AND ASSOCIATED PRODUCTS

(75) Inventors: Dennis Doweidt, Magnolia, TX (US); John Yackey, Brenham, TX (US)

(73) Assignee: Longwood Elastomers, Inc.

(21) Appl. No.: 13/117,983

(22) Filed: May 27, 2011

Related U.S. Application Data
(60) Provisional application No. 61/349,044, filed on May 27, 2010.

(51) Int. Cl. E21B 33/12; B29C 63/06

(52) U.S. Cl. 166/118; 156/188

(57) ABSTRACT

Embodiments of the present invention provide a process for manufacturing swellable packers with reinforcing fabrics and associated products used for sealing off chambers within well bores. According to one embodiment, the swellable packer is formed around a pipe by embedding a sheet of the reinforcing fabric within layers of a swellable polymer wrapped around the pipe. A sheet of reinforcing fabric is situated near each end of the swellable packer. Thus, as exposure to oil or water will cause the swellable packer to expand, the reinforcing fabric will initially retard swelling at the ends to allow for greater initial swelling along the center portion. The reinforcing fabric also strengthens the polymer to resist tearing or breakage caused by the flow of oil or water. A pair of swellable packers according to embodiments of the present invention can be placed on a pipe and placed within a bore and exposed to oil or water to create a pressurized chamber.

### CROSS-REFERENCE TO RELATED APPLICATIONS

The present invention claims priority from U.S. Provisional Patent Application No. 61/349,044, filed on May 27, 2010, which is incorporated herein by reference in its entirety.

### FIELD OF THE INVENTION

The present invention relates to improved manufacturing processes for downhole packers and associated products, and in particular downhole packers that have improved sealing characteristics.

### BACKGROUND OF THE INVENTION

In the oil and natural gas industries, a bore is typically formed into the earth to define a well, and oil or natural gas is withdrawn from the well. However, over time, the level of production from these wells can decrease and, as a result, several methods have been developed for increasing the oil or natural gas withdrawn from the well.

One of these methods involves sealing a section of the bore wall at a location above the bottom of the well. In particular, one or more plugs can be placed along the depth of the bore that seal against the bore wall. Between two of these plugs, or between one plug and the top or the bottom of the well, a chamber can be defined. These chambers are then subjected to very high pressures of water or other fluids so as to cause the walls of the bore to fracture. This can create additional flow of oil or natural gas into the chamber after the pressure is released.

Conventionally, these plugs have been formed of concrete or other cementitious materials. However, the concrete can degrade over time and leak. To improve upon concrete plugs, the industry has developed swellable packers made from polymers that swell when exposed to oil and/or water. The swellable packer is sized to have an outer diameter just smaller than the diameter of the bore and then it is placed down the bore in an unswelled state. Oil or water is then brought into contact with the swellable packer. However, pressure from the impact of oil or water may cause pieces of polymer to tear or break away. The polymer of the swellable packer begins to swell as it takes on the oil or water. This swelling causes the swellable packer to seal against the wall of the bore and create a seal so that pressurized chambers can be defined for fracturing the bore wall.

One measure of performance of these swellable packers is the amount of pressure to which the pressurized chambers can be exposed before the swellable packers begin to leak. Chamber pressures of at least 4,000 psi are achievable with conventional technology. However, it is desirable to achieve even higher chamber pressures, to allow more oil or gas production.

### BRIEF SUMMARY OF THE INVENTION

These and other advantages are provided by the swellable downhole packers and improved processes of manufacturing provided by the present invention. Advantageously, embodiments of the present invention provide a reinforcing fabric in conjunction with a swellable polymer to provide improved sealing pressures. The reinforcing fabric according to one embodiment is provided at the ends of the swellable packers and can retard swelling of the swellable polymer at those locations. This retardation of the swelling at the ends of the packers allows for more swelling along the center portion of the packer before the ends of the packer are fully swollen. As such, improved sealing pressures are achievable.

### BRIEF DESCRIPTION OF THE DRAWINGS

Having thus described the invention in general terms, reference will now be made to the accompanying drawings, which are not necessarily drawn to scale, and wherein:

FIG. 1 is a partially sectional view of an oil or gas well showing the position of two swellable packers in a bore;

FIG. 2 is a perspective view of a swellable packer according to embodiments of the present invention;

FIG. 3 is an expanded and partially sectioned view of one end of a swellable packer according to embodiments of the present invention; and

FIG. 4 is a plan view of a reinforcing fabric according to embodiments of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

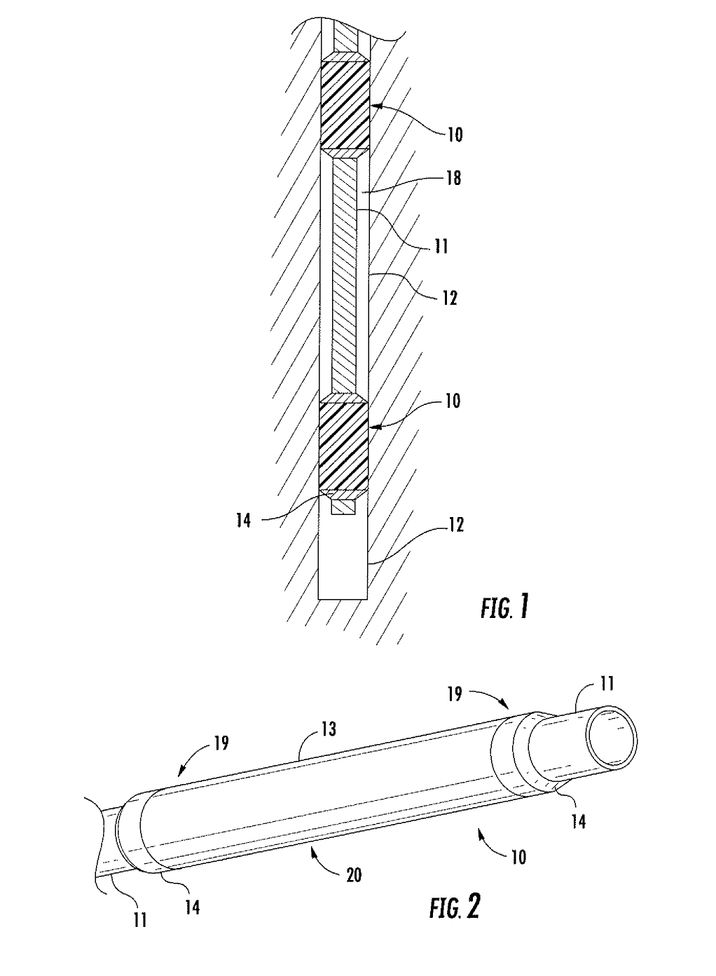

FIG. 1 illustrates an oil or natural gas well that defines a bore 12. Positioned in the bore 12 are two swellable packers 10. These swellable packers 10, when fully swollen, create a chamber 18 that can be pressurized between the swellable packers. The swellable packers 10, in the illustrated embodiment, are both supported on a support tube 11. This support tube 11 can be made of a steel pipe or any other suitable material. In some embodiments, the support tube 11 could be used as a conduit for oil, gas or other fluids, and/or could be used for allowing other downhole components to extend down the bore. The support tube 11 may also be completely or partially blocked along its length.

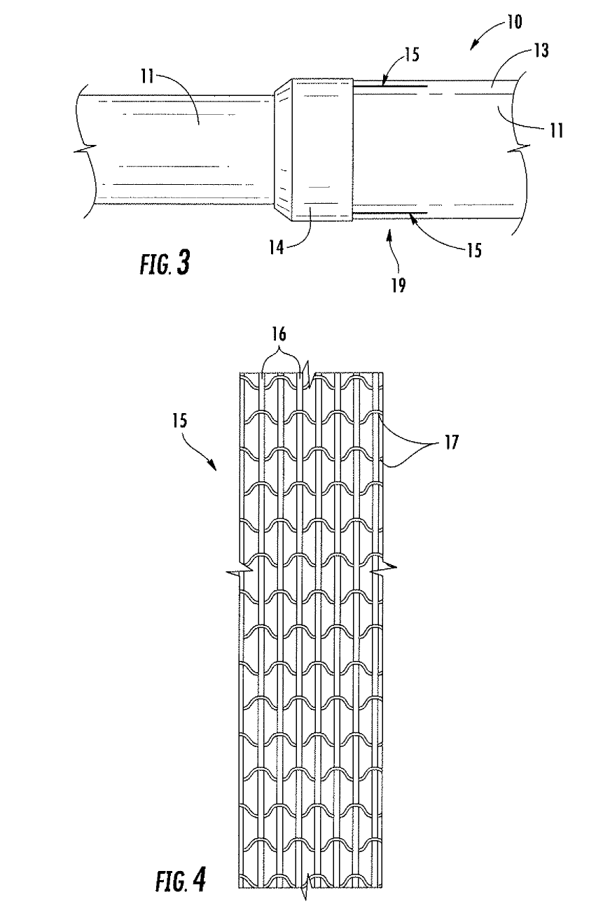

FIG. 2 is a closer view of one of the swellable packers 10. The swellable packer 10 of the illustrated embodiment is comprised of a swellable polymer 13 that is secured to the support tube 11. The swellable packer 10 should define a length along the support tube 11 sufficient to adequately seal the bore, and in one embodiment this length may be 24″. The swellable packer may be provided with end caps 14 at one or both ends of the swellable packer. The end caps 14 can be formed of metal or other resilient material and have a chamfered or tapered portion (as best seen in FIG. 3) that helps guide the swellable packer 10 through the bore as the support tube 11 is lowered or raised in the bore.

According to embodiments of the present invention, the swellable polymer 13 can be applied to the support tube 11 by wrapping a continuous sheet of swellable polymer around the support tube so as to define multiple layers. The first layer of the swellable polymer 13 can be secured to the support tube with a bonding agent. One bonding agent that is effective is THIXON 532-A-EFAPH available from Dow Chemical.

In an exemplary embodiment, a sheet of swellable polymer material is 24″ in width and is wrapped around the support tube 16 times. The thickness of the sheet of swellable polymer according to one embodiment is 0.045″, although the thickness of the sheet can increase as the winding around the support tube 11 continues. After the wrapping process has been finished, the swellable polymer 13 can be subjected to a curing process such as in a steam autoclave. This curing process can cause the various wrapped layers to bond together and define a substantially homogeneous thickness to the swellable polymer.

One particularly advantageous swelling polymer 13 is available from Tendeka under model no. JSSEO-5. This proprietary formulation provides strong swelling and sealing characteristics. However, other swellable polymers from other manufacturers could be used in embodiments of the present invention.

To achieve a desired tolerance on the outside diameter of the cured swellable packer, the swellable polymer 13 (while supported on the support tube 11) can be subjected to a machining operation, such as turning on a lathe. The end caps 14 can then be placed over the ends of the swellable polymer 13 and bonded in place with the bonding agent.

When swellable packers 10 are placed in a bore and exposed to oil or water to initiate the swelling process, the inventors have recognized that the swelling begins at the end portions 19 of the swellable polymer that are first exposed to the oil or water. The swelling process is not instantaneous and so, as the swelling proceeds, the end portions 19 of the swellable polymer 13 swell faster than central portion 20 of the swellable polymer. The inventors have recognized that this sequence can have a deleterious effect on the overall sealing pressure of the swellable packer because the central portion of the swellable polymer 13 may not swell as much as the end portions 19 of the swellable polymer. As such, the outward pressure exerted on the bore wall will not be uniform along the length of the swellable packer 10, and will he higher at the end portions 19 of the swellable packer exposed to the oil or water. Thus, the configuration of a conventional swellable packer does not allow the swellable polymer to fully swell along its length. The end portions 19 seal the central portion 20 from receiving sufficient oil or water to fully swell.

FIG. 3 is an expanded and partially sectioned view of one end of a swellable packer 10 according to embodiments of the invention. The illustrated end of the swellable packer 10 includes a reinforcing fabric 15 extending along a length at the end of the swellable packer. The reinforcing fabric 15 is positioned in the illustrated embodiment at a depth below the outer surface of the swellable polymer 13. In one embodiment, the reinforcing fabric 15 is inserted during the winding process for the sheet of swellable polymer after a first section of sheet has been wrapped but before a second section is wrapped. For example, the reinforcing fabric 15 is inserted after the 12^{th} wrap of 16 total wraps has been completed. This forms a swellable pack including an inner annulus of swellable polymer radially inward of the reinforcing fabric and an outer annulus of swellable polymer radially outward of the reinforcing fabric. In some embodiments, the reinforcing fabric 15 has a bonding agent applied thereto to bond with the swellable polymer.

In one embodiment of the manufacturing method according to the present invention, the reinforcing fabric 15 is first positioned between two sheets of swellable polymer and then the assembly is calendered to define a sandwich structure having a thickness of approximately 0.040″. This sandwich structure is then inserted during the wrapping process. The sandwich structure has more flexural strength than the reinforcing fabric 15 by itself, which makes it easier to insert during the wrapping process.

In addition, in some embodiments, the reinforcing fabric 15 may not extend all the way to the end face of the swellable polymer 13 so as to be fully encapsulated within the swellable polymer. If the reinforcing fabric 15 extends all the way to the end face, it could present a possibility for the portion of the swellable polymer radially outside of the reinforcing fabric 15 to swell disproportionately more quickly than the portion radially inside of the reinforcing fabric because oil or water would have an additional path (i.e. along the fabric) to cause swelling. In some circumstances, this could cause delamination and failure of the swellable packer. In one embodiment, the reinforcing fabric 15 is one-third the length of the swellable polymer 13, as measured along the axis of the support tube 11, and the reinforcing fabric 15 ends 0.125 inches from the end cap 14. As illustrated, the reinforcing fabric 15 can be 3 inches in length.

One embodiment of reinforcing fabric is shown in more detail in FIG. 4, and includes relatively stronger fibers 16 extending in a warp direction and relatively weaker fibers 17 extending in a weft direction. The reinforcing fabric 15 is positioned during the manufacturing process so that the relatively stronger fibers 16 are aligned with the axis of the support tube 11 and the weaker fibers 17 extend generally circumferentially around the axis of the support tube 11. However, the fibers of the reinforcing fabric may have the same tensile strength in both the warp and weft directions, and in another embodiment, the fibers extending in one direction, such as the warp direction, may be more densely spaced than in the other direction.

As oil or water is introduced into the bore to begin the swelling process, the oil or water is first contacted against the end portions 19 of the swellable polymer. The reinforcing fabric 15 strengthens the end portions 19 and prevents the swellable polymer from tearing or breaking away. Furthermore, rather than swelling at a rate faster than the central portion 20 of the swellable polymer, the reinforcing fabric 15 retards the swelling process by mechanically restraining the end portions 19 of the swellable polymer from swelling more quickly than the central portion 20. This retardation of the swelling of the end portions 19 allows the central portion 20 of the swellable polymer to swell at a comparable rate and thus create a tighter seal against the walls of the bore.

According to some embodiments of the invention, after some swelling of the end portions 19 has occurred, the relatively weaker fibers 17 can rupture, thus allowing the relatively stronger fibers 16 to separate in a circumferential direction and then the swelling of the end portions of the swellable polymer to continue without circumferential retardation. The relatively stronger fibers help reinforce the swellable polymer 13 after it has swollen, which is advantageous because the strength of the polymer decreases when it is swollen. Thus, after the installation process has been completed, the amount of swelling exhibited by the swellable polymer is more uniform along its length than in conventional packers, thus creating a stronger seal. Indeed, sealing pressures of up to 7,500 psi have been achieved with a 6 foot length of the swellable packer having reinforcing fabric 24 inches long at each end. Such a sealing pressure is of great benefit to the oil and gas industry and allows improved production of oil and gas wells.

In the embodiment depicted in FIG. 4, the reinforcing fabric 15 is a cloth material. In another embodiment, the reinforcing fabric 15 can comprise tire cord, and in particular nylon fabric intended for use in the construction of tires. One commercially-available product that is suitable is LNF085, a nylon leno weave available from Firestone Fibers & Textiles Company in Kings Mountain, N.C. However, in various other embodiments, the reinforcing fabric may be formed of other types of material, such as wire, carbon fibers, basalts, etc.

Although a single strip of reinforcing fabric 15 is illustrated at both ends of the swellable packer 10, other embodiments include multiple layers of reinforcing fabric and layers of reinforcing fabric extending further along the length of the swellable packer 10. In order to achieve a more uniform swell profile after installation, some embodiments of the invention include two layers of reinforcing fabric at the ends of the swellable packer, a single layer of reinforcing fabric adjacent to those end portions, and a central portion with no reinforcing fabric provided. A more uniform swell profile may also be provided by reinforcing fabrics that have circumferential strength that varies along the length of the fabric.

That which is claimed:

1. A method for manufacturing a swellable packer comprising:
wrapping a first section of swellable material around a tubular member to define an inner annulus of a swellable member;
inserting at least one reinforcing member between the inner annulus and a second section of swellable material, and
wrapping the second section of the swellable member around the inner annulus to define an outer annulus of the swellable member.

2. The method of claim 1, wherein the wrapping steps comprise wrapping swellable material in the form of a polymer sheet and the inserting step comprises inserting a fabric as the least one reinforcing member.

3. The method of claim 1, wherein the inserting step further comprises inserting a reinforcing member adjacent to an end of the swellable member.

4. The method of claim 3, wherein the inserting step comprises inserting the reinforcing member adjacent to but spaced from the end of the swellable member.

5. The method of claim 1, further comprising inserting the at least one reinforcing member between two sheets of swellable polymer before inserting the reinforcing member and two sheets of swellable polymer between the inner annulus and second section of swellable material.

6. The method of claim 2, further comprising inserting a fabric having stronger fibers extending in one direction and weaker fibers extending perpendicularly thereto, and orienting the fabric so that the stronger fibers extend in a direction aligned with an axis of the tubular member.

7. The method of claim 1, further comprising the step of securing the inner annulus to the tubular member with a bonding agent.

8. The method of claim 1, further comprising the step of subjecting the swellable member to a curing process.

9. The method of claim 1, further comprising the step of securing an end cap on at least one of the ends of the swelling member.

10. A swellable packer for use in a bore comprising:
a swellable member circumferentially disposed about an axis of a tubular member, wherein the thickness of the swellable member includes an inner annulus and an outer annulus; and
at least one reinforcing member interposed between the inner annulus and the outer annulus.

11. The swellable packer of claim 10, wherein the swellable member is formed from at least one sheet of polymer.

12. The swellable packer of claim 11, wherein each of the inner annulus and the outer annulus comprises a plurality of layers of the sheet of polymer.

13. The swellable packer of claim 10, wherein the at least one reinforcing member is adjacent to an end of the swellable member.

14. The swellable packer of claim 10, wherein the at least one reinforcing member comprises:
a set of strengthening fibers axially aligned with the tubular member; and
a set of restraining fibers circumferentially extending around the axis of the tubular member.

15. The swellable packer of claim 14, wherein the tensile strength of the strengthening fibers is generally greater than the tensile strength of the restraining fibers.

16. The swellable packer of claim 10, wherein the reinforcing member is adjacent to but spaced from the end of the swellable member.

17. The swellable packer of claim 10, wherein the reinforcing member extends approximately three inches along the axial direction.

18. The swellable packer of claim 14, wherein the strengthening fibers are arranged more densely than the restraining fibers.

19. The swellable packer of claim 10, wherein the swellable member entirely surrounds the reinforcing member.

20. The swellable packer of claim 10, wherein at least one end of the swellable member is covered by an end cap.

21. The swellable packer of claim 10, wherein the at least one reinforcing member comprises a sandwich assembly comprised of a reinforcing layer positioned between two swellable layers.

22. The swellable packer of claim 21, wherein the sandwich assembly has a thickness of approximately 0.040 inches.

23. A packer system for use in a bore comprising:
a tubular member;
at least one swellable packer disposed about the tubular member, wherein the at least one swellable packer comprises:
a swellable member circumferentially disposed about an axis of a tubular member, wherein the thickness of the swellable member includes an inner annulus and an outer annulus; and
at least one reinforcing member interposed between the inner annulus and the outer annulus.

24. The packer system of claim 23, wherein the at least one reinforcing member comprises:
a first reinforcing member adjacent to a first end of the swellable member; and
a second reinforcing member adjacent to a second end of the swellable member.

25. The packer system of claim 23 further comprising at least two swellable packers spaced apart along the tubular member and defining a chamber therebetween.

26. The packer system of claim 23, wherein the at least one reinforcing member comprises:
a set of strengthening fibers axially aligned with the tubular member; and
a set of restraining fibers circumferentially extending around the axis of the tubular member.

27. The packer system of claim 26, wherein the tensile strength of the strengthening fibers is generally greater than the tensile strength of the restraining fibers.

28. The packer system of claim 23, wherein the reinforcing member is adjacent to but spaced from the end of the swellable member.
